(19) United States
(12) Patent Application Publication
(10) Pub. No.: US 2006/0159168 A1
(43) Pub. Date: Jul. 20, 2006

(54) Method and apparatus for encoding pictures without loss of DC components

(75) Inventors: Sung-wook Ahn, Seoul (KR); Jung-suk Hong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/294,540

(22) Filed: Dec. 6, 2005

(30) Foreign Application Priority Data
Jan. 19, 2005 (KR) 10-2005-0005030

(51) Int. Cl. H04N 11/04; H04N 7/12; H04B 1/66; H04N 11/02

(52) U.S. Cl. 375/240.03; 375/240.24; 375/240.2; 375/240.23; 375/240.12

(57) ABSTRACT

Disclosed herein is a method of encoding moving pictures or still pictures involving dividing a single frame into a plurality of blocks and encoding the blocks. The method includes: calculating an average value of pixels constituting the blocks, shifting down the pixels by the calculated average value, performing lossy encoding on the down-shifted pixel values, and performing lossless encoding on the results of the lossy encoding and the calculated average value.

### CROSS-REFERENCE TO RELATED APPLICATION

This application claims priority from Korean Patent Application No. 10-2005-0005030 filed on Jan. 19, 2005 in the Korean Intellectual Property Office, the disclosure of which is incorporated herein by reference in its entirety.

### BACKGROUND OF THE INVENTION

1. Field of the Invention

Apparatuses and methods consistent with the present invention relate generally to a method of compressing moving pictures and still pictures, and more particularly, to a method and an apparatus for compressing and decompressing the direct current (DC) components of pictures without loss.

2. Description of the Related Art

As communication technology such as the Internet is developed, image, text and voice communication is increasing. An existing text-based communication method is insufficient to meet customers' demand, and therefore, multimedia services that can accommodate various types of information, such as text, pictures and music, are increasing. The amount of multimedia data is vast, and therefore, large capacity storage media and broad bandwidth at the time of transmission are required. For example, a 24-bit true color image having a resolution of 640×480 requires 640×480×24 bits for a single frame; in other words, it requires about 7.37 Mbits of storage space. When the data are transmitted at a rate of 30 frames per second, a bandwidth of 221 Mbits/sec is necessary. To store a 90 minute movie, a storage capacity of about 1,200 Gbits is required. Accordingly, compression encoding is required to transmit multimedia data.

The fundamental principle of compressing data is to remove redundant data. Data can be compressed by removing spatial redundancy, such as the repetition of the same color or object in an image, by removing temporal redundancy, such as the case where the neighboring frames of a moving picture frame vary little or the case where the same sound is continuously repeated, or by removing psychological or visual redundancy which takes into account the insensitivity of humans to high frequency variation. Data compression can be classified into lossy and lossless compression, intra-frame and inter-frame compression, and symmetric and non-symmetric compression, according to whether a loss of source data occurs, whether compression is performed with respect to other frames, and whether the same time is required for compression and decompression, respectively. In addition, the case where a delay time required for compression and decompression does not exceed 50 ms corresponds to real-time compression, and the case where the frame resolution varies corresponds to scalable compression. Lossless compression is used for text data, medical data and the like, and lossy compression is chiefly used for multimedia data. Meanwhile, intra-frame compression is used to remove spatial redundancy, and inter-frame compression is used to remove temporal redundancy.

The most commonly used method for removing spatial redundancy is the Discrete Cosine Transform (hereinafter abbreviated as “DCT”). The DCT includes a process of generating DCT coefficients by converting an input image from the spatial domain to the frequency domain. Thereafter, the generated DCT coefficients are encoded in a lossy manner while passing through a quantization process.

However, when the conventional image encoding method described above is used, a problem occurs in that an undesired block artifact effect is incurred due to loss of information that occurs in a decoding process of dequantization of lossy encoded results. Such a block artifact effect, which is well known, refers to a phenomenon where boundaries between blocks are conspicuous due to a minute brightness difference between unit blocks of a decoded image. This is the phenomenon whereby finely divided blocks, resulting from processes of performing DCT and quantization on a block basis, are visible by a viewer, and the main cause of such a blocking effect occurs because portions of DC components are lost while DCT coefficients pass through quantization and dequantization. The block artifact effect degrades the visual quality of pictures; in particular, the subjective quality of pictures.

To overcome these problems, the present invention proposes a method of performing level shifting before performing DCT on pictures. However, in relation to level shifting, Korean Patent No. 162201, entitled “Image Data DC Components-Differential Pulse Code Modulation System” also disclosed a technology that uniformly shifts down the levels of the pixels of an image by 128 before performing DCT.

The operational process of Korean Patent No. 162201 is briefly described below. First, the image encoding process includes the step of dividing an image, which is to be encoded, on an 8×8 block basis and inputting the divided blocks, the step of lowering the levels of the pixels of respective blocks by 128 (that is, subtracting), the step of performing DCT on the blocks and then performing quantization, and the step of performing zig-zag scanning in a predetermined order and then performing variable length encoding, thus generating bitstreams.

Meanwhile, a decoding process corresponding to the encoding process includes the step of performing inverse variable length encoding on the input bitstreams, the step of sequentially performing dequantization and Inverse Discrete Cosine Transform (IDCT) in the scanning manner, the step of increasing by 128 (that is, adding to) the overall levels of coefficients, which are generated by the IDCT and the step of arranging the generated 8×8 blocks and reconstructing the image.

Although the patent uniformly shifts down the levels of the input pixels by 128, and then performs quantization after DCT, thus increasing the encoding efficiency, it is problematic in that the degradation of the quality of the pictures due to the partial loss of DC components and the block artifact effect still occur.

### SUMMARY OF THE INVENTION

Accordingly, the present invention has been made keeping in mind the above problems occurring in the prior art, and an aspect of the present invention is to provide a method and apparatus, which perform appropriate level shifting before performing DCT in the compression of still pictures and/or moving pictures, thus encoding and decoding DC components without loss.

Furthermore, another aspect of the present invention provides a method and an apparatus that improve the visual quality of pictures by reducing a block artifact effect.

In order to accomplish the above aspect, the present invention provides a method of encoding moving pictures and/or still pictures, the method involving dividing a single frame into a plurality of blocks and encoding the blocks, and comprising: calculating an average value of pixels constituting blocks; shifting down the pixel values by the calculated average value; performing lossy encoding on the down-shifted pixels; and performing lossless encoding on results of the lossy encoding and the calculated average value.

In addition, the present invention provides a method of decoding moving pictures or still pictures, the method comprising: extracting a block average of values of pixels constituting each of predetermined blocks of a frame and text data of the blocks from an input bitstream; performing lossy decoding on the extracted text data; of shifting up results of the lossy decoding based on the block average; and reconstructing a frame by combining blocks reconstructed according to the up-shifting result.

In addition, the present invention provides an apparatus for encoding moving pictures and/or still pictures involving dividing a single frame into a plurality of blocks and encoding the blocks, and comprising: a unit which calculates an average of values of pixels constituting each of the blocks; a unit which shifts down values of the pixels by the calculated average; a unit which performs lossy encoding on the down-shifted values of the pixels; and a unit which performs lossless encoding on results of the lossy encoding and the calculated average.

In addition, the present invention provides an apparatus for decoding moving pictures and/or still pictures. The apparatus comprises: a unit which extracts an average of values of pixels constituting each of predetermined blocks of a frame and text data of the blocks from an input bitstream; a unit which performs lossless decoding on the extracted text data; a unit which shifts up results of the lossless decoding based on the average; and a unit which reconstructs a frame by combining blocks reconstructed as a result of the up-shifting.

### BRIEF DESCRIPTION OF THE DRAWINGS

The above and other aspects, features and advantages of the present invention will be more clearly understood from the following detailed description taken in conjunction with the accompanying drawings, in which:

FIG. 1 is a block diagram showing the construction of a moving picture encoder according to an exemplary embodiment of the present invention;

FIG. 2 is a diagram illustrating an example of dividing a residual frame on a block basis;

FIG. 3 is a block diagram showing the construction of a still picture encoder according to an exemplary embodiment of the present invention;

FIG. 4 is a block diagram showing the construction of a moving picture decoder corresponding to the moving picture encoder of FIG. 1 according to an exemplary embodiment of the present invention;

FIG. 5 is a block diagram showing an example of reconstructing a residual frame from reconstructed residual blocks;

FIG. 6 is a block diagram showing the construction of a still picture decoder corresponding to the still image encoder of FIG. 3 according to an exemplary embodiment of the present invention;

FIG. 7A is a diagram showing an example of picture blocks that are input to the DCT;

FIG. 7B is a diagram showing an example of a quantization table;

FIGS. 8A to 8C are diagrams illustrating a process in which the blocks of FIG. 7A are converted step by step according to the prior art; and

FIGS. 9A to 9C are diagrams illustrating a process in which the blocks of FIG. 7A are converted step by step according to an exemplary embodiment of the present invention.

### DESCRIPTION OF THE EXEMPLARY EMBODIMENTS

The exemplary embodiments of the present invention are described in detail with reference to the accompanying drawings below.

Advantages and features of the present invention and methods for accomplishing them will be apparent with reference to the exemplary embodiments, which will be described in detail later, along with the accompanying drawings. However, the present invention is not limited to the exemplary embodiments disclosed below, but may be implemented in various forms. The present exemplary embodiments only allow the disclosure of the present invention to be complete, and are provided to fully notify those skilled in the art of the scope of the invention. The present invention is defined only by the appended claims. The same reference numerals are used across the drawings to designate the same or similar components.

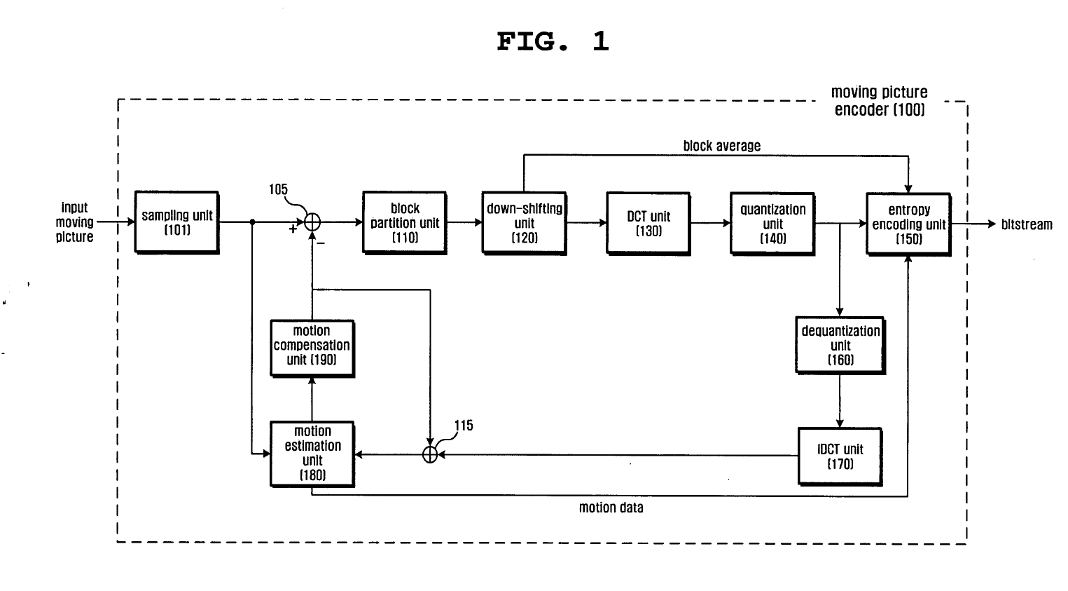

FIG. 1 is a block diagram showing the construction of a moving picture encoder 100 according to an exemplary embodiment of the present invention. The moving picture encoder 100 may include a sampling unit 101, a block partition unit 110, a down-shifting unit 120, a DCT unit 130, a quantization unit 140, an entropy encoding unit 150, a motion estimation unit 180, and a motion compensation unit 190. Furthermore, the moving picture encoder 100 may further include a dequantization unit 160 and an IDCT unit 170 to perform closed-loop encoding.

The sampling unit 101 performs spatial sampling and temporal sampling on input moving pictures. Spatial sampling refers to sampling moving pictures (analog signals) on a pixel basis and generating frames, each of which includes a predetermined number of pixels, and temporal sampling refers to generating frames according to a predetermined frame rate. The two kinds of sampling are performed through the sampling unit 101 and then the following tasks are performed on a frame basis.

The motion estimation unit 180 performs motion estimation of a current frame based on a predetermined reference frame, and obtains a motion vector. A block matching algorithm is widely used for the motion estimation. That is, the displacement of a given motion block, in which the error is minimal while the motion block moves within a specific search region of the reference frame on a pixel basis, is estimated as a motion vector. Motion blocks having fixed sizes may be used to perform the motion estimation. Furthermore, the motion estimation may be performed using motion blocks having variable sizes based on Hierarchical Variable Size Block Matching (HVSBM). The motion estimation unit 180 sends motion data, which are obtained as the result of the motion estimation, to the entropy encoding unit 150. The motion data includes one or more motion vectors, and may further include information about motion block sizes and reference frame numbers.

The motion compensation unit 190 reduces temporal redundancy of the input video frame. In this case, the motion compensation unit 190 performs motion compensation on the reference frame using the motion vector calculated by the motion estimation unit 180, thus generating a temporally predicted frame with respect to the current frame.

A subtractor 105 subtracts the temporally predicted frame from the current frame, thus removing the temporal redundancy of the current frame, and generating a residual frame.

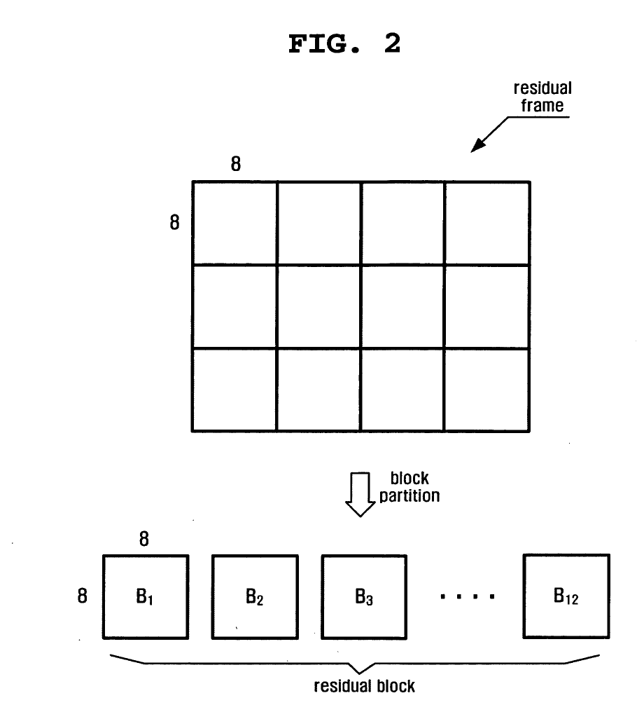

The block partition unit 110 divides a signal output from the subtractor 105, that is, a residual frame, into a plurality of blocks (residual blocks) each having a predetermined size. The size of the blocks becomes a unit for the following DCT, and each of the blocks has a 4×4 pixel size or an 8×8 pixel size according to the DCT unit. This is only an example, and the blocks may have different pixel sizes according to the DCT unit. For ease of description, the case where each of the blocks has an 8×8 pixel size, and therefore, an 8×8 DCT is later performed, will be described. An example in which the residual frame is divided on a block basis by the block partition unit 110 is as shown in FIG. 2.

When the down-shifting unit 120 receives a current block (any one of the blocks included in the current frame) from the block partition unit 110, it obtains the average (hereinafter refers to as “block average”) of the values of pixels constituting the current block, and shifts down the values of the pixels by the block average. That is, the block average is subtracted from the value of each of the pixels.

The block average M can be obtained using the following Equation 1. In this case, N is the size of the current block (when the size of the current block is 8×8, N=8), and Aᵢⱼ designates the pixel values of the current block.

$$M = \frac{1}{{N}^{2}} {\sum }_{i = 0}^{N - 1} {\sum }_{j = 0}^{N - 1} {A}_{ij} \qquad ( 1 )$$

Thereafter, modified pixel values Xᵢⱼ, which are generated as a result of down-shifting, may be calculated using the following Equation 2.
Xᵢⱼ=Aᵢⱼ−M (2)

In the present invention, when the pixel values of the current block are shifted down by the block average and then DCT is performed, a DC component obtained as a result will be 0. Meanwhile, the block average obtained for the down-shifting unit 120 is transferred to the entropy encoding unit 150 and is then encoded without loss.

Meanwhile, the down-shifted pixel values are encoded in a lossy manner while passing through the DCT unit 130 and the quantization unit 140.

More specifically, the DCT unit 130 performs DCT on the down-shifted blocks using the following Equation 3, thus generating DCT coefficients. The DCT, which is a process of converting input pixel values into values in a frequency domain, is a technique that is commonly used to remove spatial redundancy.

In Equation 3, Y_{xy} designates coefficients (hereinafter referred to as “DCT coefficients”) generated by performing DCT, Xᵢⱼ designates the modified pixel values input to the DCT unit 130, and N refers to a DCT conversion unit. When the residual frame is divided into blocks each having an 8×8 pixel size by the block partition unit 110, N=8.

$${Y}_{xy} = {C}_{x} {C}_{y} {\sum }_{i = 0}^{N - 1} {\sum }_{j = 0}^{N - 1} {X}_{ij} cos \frac{( 2 j + 1 ) y π}{2 N} cos \frac{( 2 i + 1 ) x π}{2 N} ; \\ where {C}_{k} = \sqrt{\frac{1}{N}} ( k = 0 ) , and {C}_{k} = \sqrt{\frac{2}{N}} ( k > 0 ) . \qquad ( 3 )$$

The quantization unit 140 quantizes the DCT coefficients to generate quantization coefficients. However, due to the down-shifting process, the DC components will be 0, so that the loss of DC components will not occur even though the quantization process will be performed.

In this case, the quantization refers to a process of dividing conversion coefficients, that is the DCT coefficients, which are expressed as arbitrary real numbers, at a predetermined interval, and expressing the divided coefficients as discrete values. Although, the scalar quantization method and the vector quantization method are well known, the scalar quantization method is described as an example.

In the scalar quantization method, coefficients Q_{xy} (hereinafter referred to as “quantization coefficients”), which are generated as the result of quantization, can be obtained using the following Equation 4, where round ( . . . ) refers to a rounding-off function, and S_{xy} refers to a step size. The step size is determined based on an N×N (in the present example, 8×8) quantization table. Quantization tables provided by JPEG and MPEG standards can be used as the quantization table, but the quantization table is not necessarily limited to these.

$${Q}_{xy} = round ( \frac{{Y}_{xy}}{{S}_{xy}} ) \qquad ( 4 )$$

where x=0, . . . , N−1, and y=0, . . . , N−1

The entropy encoding unit 150 encodes the generated quantization coefficients, motion data, which is provided by the motion estimation unit 180, and the block average, which is transferred from the down-shifting unit 120 without loss, thus generating bitstreams. As the lossless encoding method, various methods, such as arithmetic encoding, variable length encoding, and Huffman encoding, may be used.

The moving picture encoder 100 may further include the dequantization unit 160 and the IDCT unit 170 in the case where closed-loop encoding is supported in order to decrease a drifting error generated between the encoder and the decoder.

The dequantization unit 160 performs dequantization (the inverse of the quantization process) on the quantized coefficients generated by the quantization unit 140. Furthermore, the IDCT unit 170 performs IDCT on the result of the dequantization and provides the result to an adder 115.

The adder 115 adds the result of the IDCT to the previous frame provided from the motion compensation unit 190 (stored in a frame buffer which is not shown), reconstructs the video frame, and provides the reconstructed video frame to the motion estimation unit 180 as a reference frame.

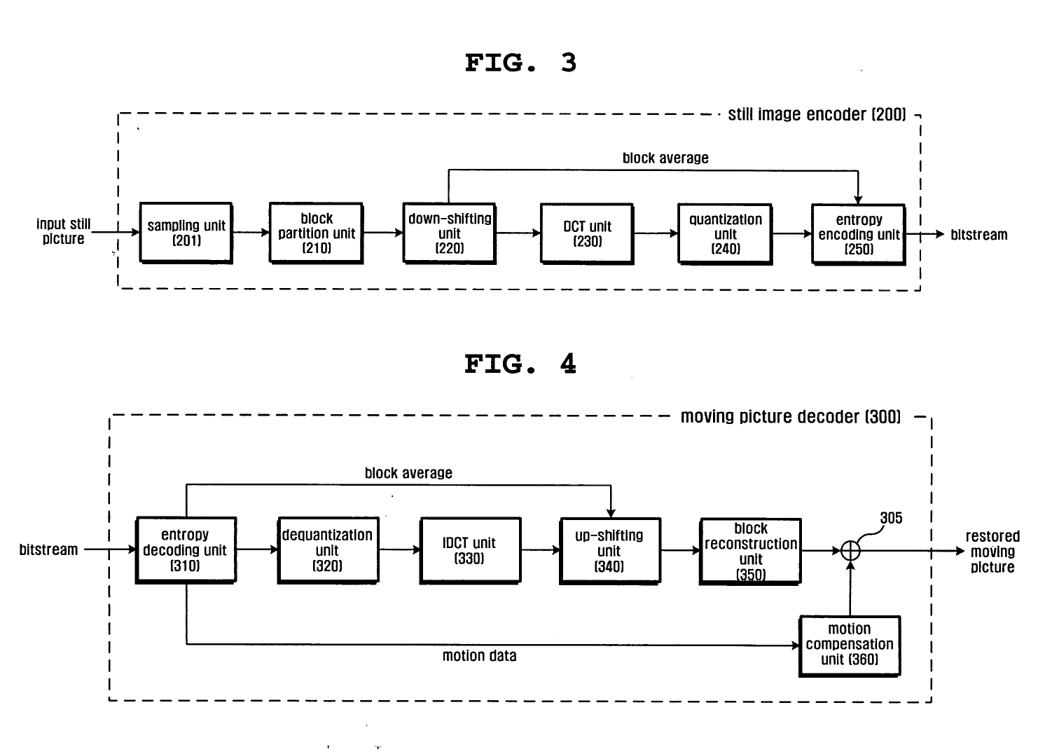

Meanwhile, the present invention may be used for encoding of still pictures as well as for the encoding of moving pictures. FIG. 3 is a block diagram showing the construction of a still picture encoder 200 according to an embodiment of the present invention. The still picture encoder 200 may include a sampling unit 201, a block partition unit 210, a down-shifting unit 220, a DCT unit 230, a quantization unit 240, and an entropy encoding unit 250.

In encoding still pictures, none of the operations associated with the removal of temporal redundancy are necessary. Accordingly, the motion compensation unit 190 and the motion estimation unit 180 are not necessary, and the dequantization unit 160 and the IDCT unit 170, which are used for closed-loop encoding, are also not necessary. Accordingly, the still picture encoder 200 has a simpler construction than the construction of FIG. 1. Since the operations of the sampling unit 201, the block partition unit 210, the down-shifting unit 220, the DCT unit 230, the quantization unit 240, and the entropy encoding unit 250 are the same as in FIG. 1, descriptions thereof are omitted.

The sampling unit 201 only performs spatial sampling on an input still picture, and it generates a frame; it does not need to perform the temporal sampling process, unlike the sampling unit 101 of FIG. 1. Furthermore, the entropy encoding unit 250 encodes quantization coefficients, which are generated by the quantization unit 240, and a block average, which is transferred from the down-shifting unit 220 without loss, but the entropy encoding unit 250 does not encode motion data because it does not exist.

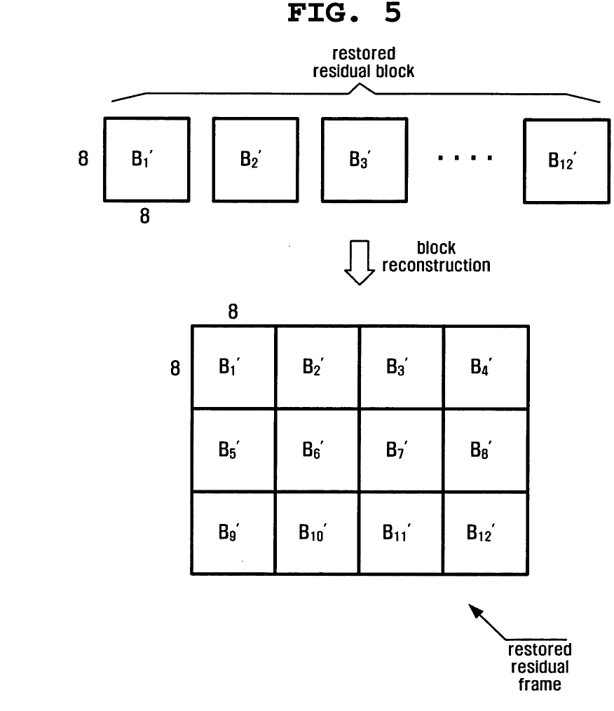

FIG. 4 is a block diagram showing the construction of a moving picture decoder 300 corresponding to the moving picture encoder of FIG. 1 according to an exemplary embodiment of the present invention. The moving picture decoder 300 may include an entropy decoding unit 310, a dequantization unit 320, an IDCT unit 330, an up-shifting unit 340, a block reconstruction unit 350, and a motion compensation unit 360.

The entropy decoding unit 310 performs lossless decoding, in contrast to the entropy encoding manner, and extracts motion data, a block average, and text data (dequantization coefficients) for respective blocks. The text data is provided to the dequantization unit 320, the motion data is provided to the motion compensation unit 360, and the block average is provided to the up-shifting unit 340.

Meanwhile, the extracted text data is decoded in a lossy manner while passing through the dequantization unit 320 and the IDCT unit 330.

More specifically, the dequantization unit 320 dequantizes the text data transferred from the entropy decoding unit 310. According to the present invention, DC components are 0 and do not change even in the dequantization process, so that the loss of the DC components does not occur.

The dequantization process uses the same quantization table as in the moving picture encoder 100. Coefficient Y′_{xy}, generated as a result of the dequantization, may be calculated using the following Equation 5. Y′_{xy} calculated in the Equation 5 differs from Y_{xy}. This is because lossy encoding using a rounding off function has been used in Equation 4.
Y_{xy}^{′}=Q_{xy}×S_{xy} (5)

The IDCT unit 330 performs IDCT on the dequantization result. The result of the IDCT, X′ᵢⱼ, can be calculated by, for example, the following Equation 6.

$${X}_{ij}^{′} = {\sum }_{x = 0}^{N - 1} {\sum }_{y = 0}^{N - 1} {C}_{x} {C}_{y} {Y}_{xy}^{′} cos \frac{( 2 j + 1 ) y π}{2 N} cos \frac{( 2 i + 1 ) x π}{2 N} \qquad ( 6 )$$

The up-shifting unit 340 shifts up the result of the IDCT by the block average provided from the entropy decoding unit 310. The up-shifting result A′ᵢⱼ can be calculated using the following Equation 7, where A′ᵢⱼ designates the respective pixel values of the reconstructed residual blocks.
Aᵢⱼ^{′}=Xᵢⱼ^{′}+M (7)

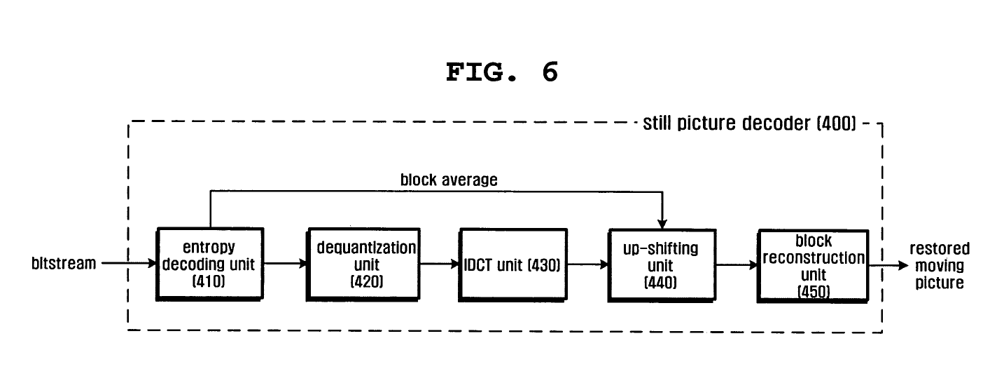

The block reconstruction unit 350 reconstructs the residual frame by combining the reconstructed residual blocks according to Equation 7. In the case where blocks are divided as shown in FIG. 2 in the moving picture encoder 100, an example, in which the block reconstruction unit 350 reconstructs the residual frame from the reconstructed residual blocks (B₁′ to B₁₂′) according to the partition, is as shown in FIG. 5.

The motion compensation unit 360 generates a motion compensation frame from the previously reconstructed video frame using the motion data provided from the entropy decoding unit 310. Thereafter, an adding unit 305 adds the residual frame reconstructed by the block reconstruction unit 350 to the motion compensation frame provided from the motion compensation unit 360, so that the moving pictures are reconstructed. The operations in the motion compensation unit 360 and the adding unit 305 are applied only in the case where the current frame is encoded through the temporal prediction process of the moving picture encoding unit 100.

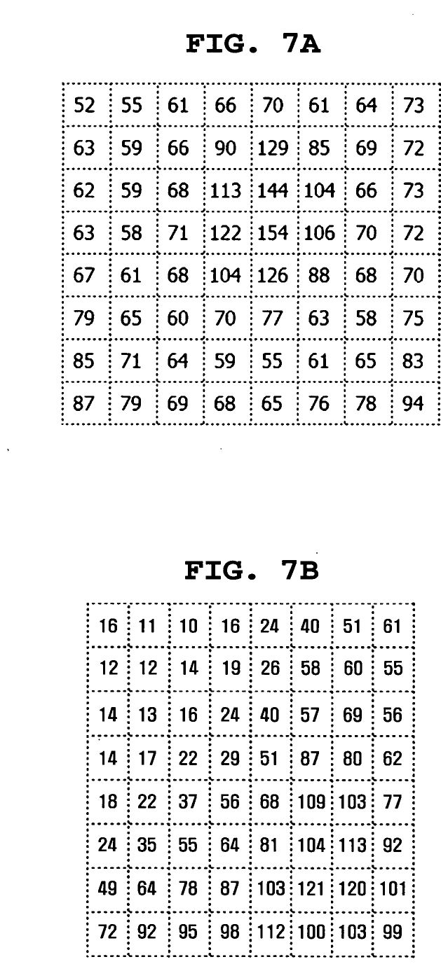

FIG. 6 is a block diagram showing the construction of a still picture decoder corresponding to the still picture encoder of FIG. 3 according to an exemplary embodiment of the present invention. The still picture decoder 400 may include an entropy decoding unit 410, a dequantization unit 420, an IDCT unit 430, an up-shifting unit 440, and a block reconstruction unit 450. In the still picture decoder 400, the motion compensation unit 360 and the adding unit 305 are not used because operations associated with temporal redundancy are unnecessary, and motion data is not used either. The construction of FIG. 6 is the same as that of FIG. 4, and descriptions have been omitted.

The respective components of FIGS. 1, 3, 4 and 6 may refer to software and hardware, such as Field-Programrnmable Gate Arrays (FPGAs) or Application-Specific Integrated Circuits (ASICs). The components may be constructed to reside in an addressable storage media, or they may be constructed so as to reproduce one or more processes. The functions provided within the components may be realized by more subdivided components, or an aggregation of the components may be realized as a single component that performs a specific function.

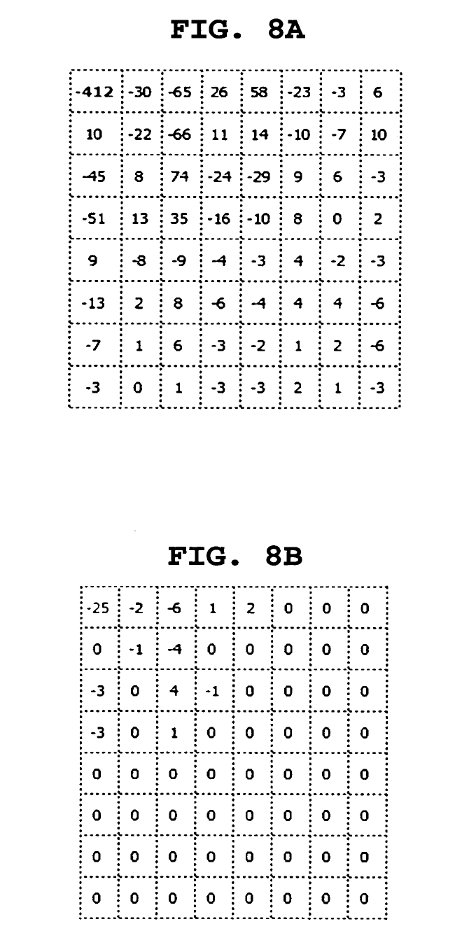

The comparison between Korean Pat. No. 162201 and the present invention will be made through a specific example (below). For this purpose, it is assumed that there are blocks (block average M=76.5) having pixel values Aᵢⱼ as shown in FIG. 7A, and the quantization table shown in FIG. 7B is used.

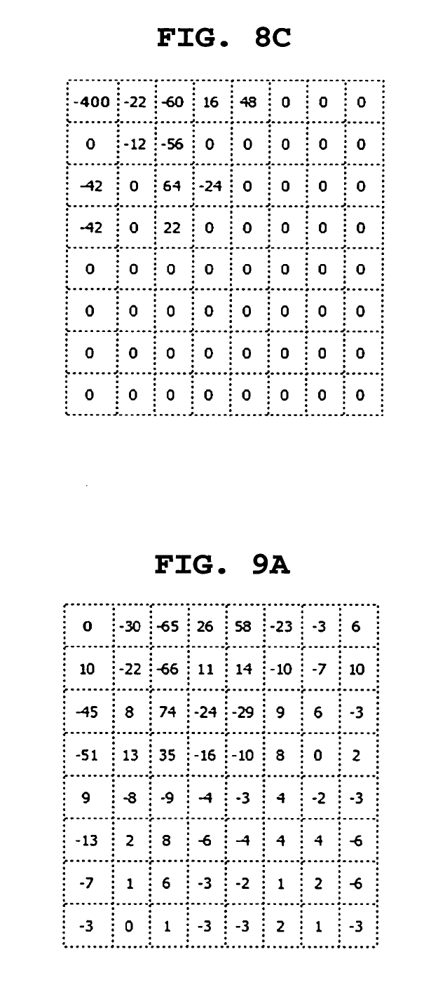

FIGS. 8A to 8C illustrate the components of blocks converted step by step according to the present invention under the previous assumption. When the values in the blocks shown in FIG. 7A are shifted down by −128 and then converted, the result is shown in FIG. 8A. The component located in the left upper corner indicates a DC value of −412. Thereafter, the DCT coefficients shown in FIG. 8A are quantized using Equation 4 and the quantization table shown in FIG. 7B, and the result is shown in FIG. 8B. Thereafter, when the values of FIG. 8B are dequantized using Equation 5 and the quantization table, the result is shown in FIG. 8C. In this case, the DC value in the dequantized blocks is −400, and therefore, an error of 12 (with respect to −412) occurs. When the values shown in FIG. 8C are converted by IDCT and an average value is calculated, an average value of 78.0 is acquired. Accordingly, an error of about 1.5, with respect to the original block average, occurs.

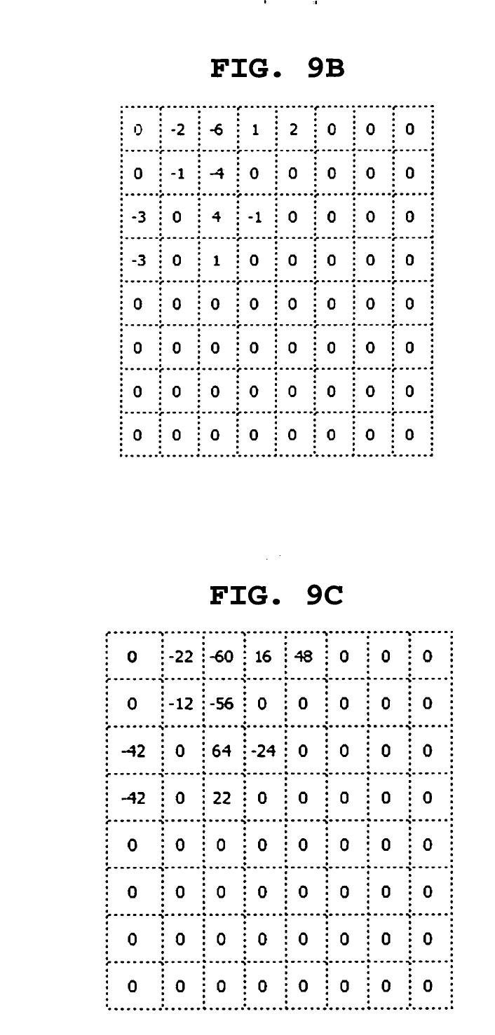

FIGS. 9A to 9C are diagrams illustrating the components of blocks converted step by step according to an exemplary embodiment of the present invention, under the same assumption described above. The values in the blocks shown in FIG. 7A are shifted down by the block average of 76.5 and are then converted by DCT. The result is shown in FIG. 9A, where it can be seen that the DC component is 0. Thereafter, when the DCT coefficients shown in FIG. 9A are quantized using Equation 4 and the quantization table shown in FIG. 7B, the result is shown in FIG. 9B. In contrast, when the values shown in FIG. 9B are dequantized by Equation 5 using the quantization table shown, the results are shown in FIG. 9C. As described above, in accordance with the present invention, the DC value is not changed even while the quantization and dequantization processes are performed. This is because the number “0” does not change when it is multiplied or divided by any value. When the dequantization result shown in FIG. 9C is converted by IDCT and is shifted up by the block average, an average of the resulting blocks is the same as the original block average of 76.5.

From the above-described features of the present invention, the DC value and the average value of each block are kept constant while some processes are performed in the encoder and the decoder.

In accordance with the present invention, DC components are reconstructed without loss when an image is decoded, so that the visual quality of the image can be improved.

Furthermore, in accordance with the present invention, a block artifact effect of the DCT and quantization processes can be reduced.

Although the exemplary embodiments of the present invention have been disclosed for illustrative purposes, those skilled in the art will appreciate that the present invention may be implemented in various forms without departing from the technical spirit or essential characteristics thereof. Accordingly, it should be understood that the above-described exemplary embodiments are illustrative but not restrictive.

What is claimed is:

1. A method of encoding at least one of moving pictures and still pictures, the method involving dividing a single frame into a plurality of blocks and encoding the blocks, and comprising:
(a) calculating an average value of values of pixels constituting each of the blocks;
(b) shifting down the values of the pixels by the calculated average value;
(c) performing lossy encoding on the down-shifted values of the pixels; and
(d) performing lossless encoding on the results of the lossy encoding and the calculated average value.

2. The method as set forth in claim 1, wherein the performing lossy encoding on the down-shifted values of the pixels comprises:
(c1) performing a Discrete Cosine Transform (DCT) on the blocks composed of the pixels having the down-shifted values; and
(c2) quantizing the DCT results.

3. The method as set forth in claim 1, wherein each of the blocks has an 8×8 pixel size.

4. The method as set forth in claim 1, wherein the frame is a residual frame in which temporal redundancy has been removed.

5. The method as set forth in claim 1, wherein the lossless encoding is one of variable length encoding, arithmetic encoding and Huffman encoding.

6. A method of decoding at least one of moving pictures and still pictures, comprising:
(a) extracting a block average of values of pixels constituting each of predetermined blocks of a frame and text data of the blocks from an input bitstream;
(b) performing lossy decoding on the extracted text data;
(c) shifting up results of the lossy decoding based on the block average; and
(d) reconstructing a frame by combining blocks which have been reconstructed according to the up-shifted result.

7. The method as set forth in claim 6, wherein the performing lossy decoding on the extracted text data comprises:
(b1) dequantizing the extracted text data; and
(b2) performing an Inverse Discrete Cosine Transform (IDCT) on the dequantization results.

8. The method as set forth in claim 6, wherein the predetermined blocks are residual blocks, and the reconstructed frame is a residual frame.

9. The method as set forth in claim 8, further comprising:
(e) extracting motion data from the input bitstream;
(f) generating a motion compensation frame from a previously reconstructed frame using the extracted motion data; and
(g) adding the reconstructed frame and the motion compensation frame.

10. An apparatus for encoding at least one of moving pictures and still pictures, the apparatus involving dividing a single frame into a plurality of blocks and encoding the blocks, and comprising:
a unit which calculates an average of values of pixels constituting each of the blocks;
a unit which shifts down the values of the pixels by the calculated average;
a unit which performs lossy encoding on the down-shifted values of the pixels; and
a unit which performs lossless encoding on results of the lossy encoding and the calculated average.

11. The apparatus as set forth in claim 10, wherein the unit which performs the lossy encoding comprises:
a unit which performs Discrete Cosine Transform (DCT) on the blocks composed of the pixels having the down-shifted values; and
a unit which quantizes the DCT results.

12. The apparatus as set forth in claim 10, wherein each of the blocks has an 8×8 pixel size.

13. The apparatus as set forth in claim 10, wherein the frame is a residual frame from which temporal redundancy has been removed.

14. The apparatus as set forth in claim 10, wherein the lossless encoding is one of variable length encoding, arithmetic encoding and Huffman encoding.

15. An apparatus for decoding at least one of moving pictures and still pictures, comprising:
a unit which extracts an average of values of pixels constituting each of predetermined blocks of a frame and text data of the blocks from an input bitstream;
a unit which performs lossless decoding on the extracted text data;
a unit which shifts up results of the lossless decoding based on the average; and
a unit which reconstructs a frame by combining blocks which have been reconstructed as a result of the up-shifting.

16. The apparatus as set forth in claim 15, wherein the unit which performs the lossy decoding comprises:
a unit which dequantizes the extracted text data; and
a unit which performs Inverse Discrete Cosine Transform (IDCT) on the dequantized results.

17. The apparatus as set forth in claim 15, wherein the predetermined blocks are residual blocks, and the reconstructed frame is a residual frame.

18. The apparatus as set forth in claim 17, further comprising:
a unit which extracts motion data from the input bitstream;
a unit which generates a motion compensation frame from the previously reconstructed frame using the extracted motion data; and
a unit which adds the reconstructed frame and the motion compensation frame.

19. A recording medium that stores a computer-recordable program implementing the method set forth in claim 1.
